(19) United States
(12) Patent Application Publication
(10) Pub. No.: US 2005/0222379 A1
(43) Pub. Date: Oct. 6, 2005

(54) Method and apparatus for synthesis of lactide

(75) Inventors: Toshiaki Matsuo, Hitachi (JP); Takayuki Matsumoto, Hitachi (JP); Naruyasu Okamoto, Tokyo (JP); Hitomi Ohara, Kyoto (JP); Seiji Sawa, Nagoya (JP); Yasuhiro Fujii, Nagoya (JP); Tatsushi Kawamoto, Togo (JP); Takashi Yatsugi, Toyota (JP)

Correspondence Address: CROWELL & MORING LLP;INTELLECTUAL PROPERTY GROUP, P.O. BOX 14300, WASHINGTON, DC, 20044-4300, US

(73) Assignees: Hitachi, Ltd., Tokyo (JP); Toyota Jidosha Kabushiki Kaisha, Aichi (JP)

(21) Appl. No.: 11/066,998

(22) Filed: Feb. 28, 2005

(30) Foreign Application Priority Data
Mar. 10, 2004 (JP) 2004-066625

(51) Int. Cl. C08G 63/08

(52) U.S. Cl. 528/359

(57) ABSTRACT

The present invention is envisaged to provide an apparatus and a process for synthesizing lactide, according to which the water content in the produced lactide can be reduced. In operation of the system, lactic acid oligomer discharge valve 10 is closed, allowing transfer of lactic acid to its polycondensing apparatus 2, and concentration and polycondensation of lactic acid are advanced by heating and evacuation, with the produced water being evaporated. Lactic acid, lactic acid oligomer and lactide are removed from the produced gaseous body by condenser 11 and refluxed to the polycondensing apparatus, and then water content in the gaseous body is measured by pressure gauge 12. After confirming that the water content is below a specified value, lactic acid oligomer discharge valve 10 is opened to allow transfer of the lactic acid oligomer, said oligomer being depolymerized to produce gaseous lactide, which is condensed and recovered.

### FIELD OF THE INVENTION

The present invention relates to a method and an apparatus for synthesizing lactide from lactic acid.

### BACKGROUND OF THE INVENTION

Polylactic acid is a colorless and transparent polyester made by using lactic acids a biomass, as starting material. One method of synthesizing polylactic acid from lactic acid comprises polycondensing lactic acid to form a lactic acid oligomer (low-molecular weight polylactic acid), depolymerizing it by adding a catalyst such as antimony oxide to produce lactide, refining it by appropriate means such as crystallization, and then adding a catalyst such as tin octylate to the lactide to carry out a ring-opening polymerization. In the step of polycondensing lactic acid to form a lactic acid oligomer, water produced by the polycondensation reaction is removed by evaporation, so that heating at a temperature of usually 120 to 250° C. and evacuation to 100 Torr or below by a vacuum pump are conducted. In this operation, lactic acid, lactic acid oligomer and lactide produced by thermal decomposition of the lactic acid oligomer may be vaporized with water and transfer toward the evacuator from the lactic acid polycondensing apparatus. These vaporized substances are usually eliminated by a cold trap or other means installed forward of the evacuator.

After carrying out sufficient reaction in the lactic acid polycondensation step, the produced lactic acid oligomer is sent to the depolymerization step. In the depolymerization step, the lactic acid oligomer is brought into contact with a depolymerization catalyst such as antimony trioxide in an environment heated at a temperature of usually 120 to 250° C. and evacuated to 100 Torr or below. The resultantly produced gaseous lactide is cooled and solidified and then recovered. In this operation, if the polycondensation reaction is insufficient, this reaction may proceed partially in the depolymerization step, too, to produce water, which may get mixed in the recovered lactide. This mixed water becomes an obstructive factor against the increase of polymerization degree in the polylactic acid polymerization step comprising ring-opening polymerization of lactide.

It was necessary, therefore, to refine lactide before it is subjected to the ring-opening polymerization reaction. As means for refinement of lactide, a method using a solvent (patent literature 1) and a method called melt crystallization (patent literature 2) have been reported. These refinement methods, however, had the problem that if water content of lactide is high, the process is complicated and also ring-opening of lactide may take place in the course of refinement to cause a reduction of yield. It was necessary, therefore, to let the lactic acid polycondensation reaction progress sufficiently to minimize the amount of water contained in lactide after depolymerization.

Patent literature 3 proposes to measure temperature in the lactic acid polycondensing apparatus and let the lactic acid polycondensation reaction proceed properly by controlling the temperature in the polycondensing apparatus. This method, however, is not designed to determine the water content in the gas phase or a physical quantity having a direct interrelation therewith. Therefore, even if the proper operation patterns concerning temperature, retention time, etc., of the lactic acid polycondensing apparatus are standardized in a manual and the equipment is operated according to such a manual, it is impossible to properly deal with the influence by variation of the amount of water contained originally in lactic acid used as the staring material. Therefore, sufficient and stable reduction of the amount of water contained in lactide after depolymerization can not be attained.
Patent literature 1: JP-A-63-101378
Patent literature 2: JP-A-6-256340
Patent literature 3: JP-A-8-208638

### BRIEF SUMMARY OF THE INVENTION

The present invention is envisioned to obtain lactide with a low water content in a lactide producing method which comprises the steps of polycondensing lactic acid under reduced pressure to produce a lactic acid oligomer and depolymerizing the obtained lactic acid oligomer.

In the course of studies aimed at achieving the above object, the present inventors found that it was possible to reduce the water content in the product lactide by following the steps of measuring water content in the gas phase in the reaction of producing a lactic acid oligomer by polycondensing lactic acid under reduced pressure, and after confirming that the measured value of water content is below a specified value, subjecting the said oligomer to a depolymerization reaction. The above finding has led to the attainment of the present invention.

The present invention, in an embodiment thereof, provides a method of producing a lactide comprising the steps of:
polycondensing a lactic acid under reduced pressure to form a lactic acid oligomer; and
depolymerizing the obtained lactic acid oligomer,
wherein a water content in a gas phase in the lactic acid polycondensation reaction is measured, and, after confirming that the measured value of water content is smaller than a specified value, said lactic acid oligomer is subjected to the depolymerization reaction.

In another embodiment, the present invention provides a method of synthesizing a lactide comprising the steps of:
using a lactide synthesizing apparatus comprising a lactic acid polycondensing apparatus, an evacuator for evacuating said lactic acid polycondensing apparatus, and a lactic acid oligomer depolymerizer;
measuring a water content in a gas phase in the polycondensation reaction by a water content meter set between said lactic acid polycondensing apparatus and said evacuator; and
after confirming that the measured value of water content is smaller than a specified value, opening a discharge port of the polycondensing apparatus to subject a resulting product to a depolymerization reaction.

In still another embodiment, the present invention offers a modification of the above-described method which further includes the step of condensing a lactic acid, a lactic acid oligomer and a lactide in the gas phase by a condenser provided between the lactic acid polycondensing apparatus and the water content meter.

In yet another embodiment of the present invention, there is provided an apparatus for synthesizing a lactide, comprising:
a lactic acid polycondensing apparatus;
an evacuator for evacuating an inside of said lactic acid polycondensing apparatus; and
a lactic acid oligomer depolymerizer,
wherein a water content meter for measuring a water content in a gas phase is set between said lactic acid polycondensing apparatus and said evacuator, and
the lactic acid polycondensing apparatus is provided with a discharge port which is opened or closed in response to an output signal from said water content meter.

In a further embodiment of the present invention, it offers the above-said apparatus further including a condenser provided between the lactic acid polycondensing apparatus and the water content meter.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic illustration of an example of a lactide producing process according to the present invention.

FIG. 2 is an enlarged illustration of an example of a lactic acid polycondensation reaction in the lactide producing process shown in FIG. 1.

### DESCRIPTION OF REFERENCE NUMERALS

1: lactic acid feeder, 2: lactic acid polycondensing apparatus, 3: lactic acid oligomer feeder, 4: depolymerizer, 5: cold trap, 6: evacuator, 7: lactide condenser, 8: lactide recovery tank, 9: lactic acid polycondensing apparatus thermometer, 10: lactic acid oligomer discharge valve, 11: condenser, 12: pressure gauge.

### DETAILED DESCRIPTION OF THE INVENTION

The lactide producing method according to the present invention comprises the steps of polycondensing lactic acid under reduced pressure to produce a lactic acid oligomer and depolymerizing the obtained lactic acid oligomer, characterized in that the water content in the gas phase in the lactic acid polycondensation reaction is measured and after confirming that the measured value of water content is below a specified value, the oligomer is subjected to a depolymerization reaction.

The lactic acid used as starting material in the present invention may be ether L-lactic acid or D-lactic acid. Any of the lactic acid preparations produced by the conventional methods can be used, but it is preferable to use lactic acid with a low water content. Use of such lactic acid makes it possible to shorten the step of concentrating the lactic acid by evaporating water contained therein and is also advantageous economically.

Water contained originally in lactic acid is removed by evaporating it by heating. Water contained in the starting lactic acid may be removed together with water generated by the polycondensation reaction of lactic acid in the lactic acid polycondensation step. Alternatively, water may be removed in advance from the starting lactic acid to concentrate lactic acid and then it may be subjected to the polycondensation step.

In the former case, the starting lactic acid is directly transported to the lactic acid polycondensing apparatus to undergo a lactic acid polycondensation reaction, while in the latter case, the lactic acid concentrating apparatus and the lactic acid polycondensing apparatus are connected in series, and after evaporating water in the lactic acid by heating it with the forwardly positioned lactic acid concentrating apparatus, the obtained lactic acid concentrate is transported to the lactic acid polycondensing apparatus to carry out a lactic acid polycondensation reaction. A lactic acid feeder may be provided forwardly of the lactic acid polycondensing apparatus or the lactic acid concentrating apparatus, with lactic acid being supplied therefrom to either of said apparatuses.

In the lactic acid polycondensation reaction, there may be added, if necessary, a catalyst for the lactic acid polycondensation reaction. It is possible to use the known catalysts, for example, organotin-based catalysts (such as tin lactate, tin tartrate, tin dicaprylate, tin dilaurate, tin dipalmitate, tin distearate, tin dioleate, tin α-naphthoate, tin β-naphthoate, and tin octylate) and powdered tin. In case the said lactic acid feeder is provided, the catalyst may be added in advance in this feeder.

In case of conducting concentration and polycondensation of lactic acid at the same time, the reaction is carried out under a pressure of 100 Torr or below, preferably 10 Torr or below, more preferably 1 Torr or below, while raising the temperature gradually up to 160 to 220° C., preferably 170 to 200° C.

When water is removed in advance from lactic acid and the concentrated lactic acid is subjected to a polycondensation reaction, the concentration reaction is carried out in an inert gas environment at a temperature of usually 100 to 170° C., preferably 130 to 140° C., under a pressure below the atmospheric pressure, for a period of usually 2 to 3 hours, and the succeeding polycondensation reaction is conducted by continuously drawing the vacuum after concentration, and after the pressure went down to 100 Torr or below, preferably 10 Torr or below, more preferably 1 Torr or below, the temperature is raised gradually to 160 to 220° C., preferably 170 to 200° C.

The temperature for the lactic acid concentration reaction is preferably set lower than the temperature for the lactic acid polycondensation reaction, but in the lactic acid polycondensation reaction, since a large amount of water is evaporated in this reaction, a greater degree of evacuation than in the concentration reaction is applied. Therefore, in the lactic acid polycondensing apparatus is preferably installed an evacuator with a higher capacity than in the concentrating apparatus.

Both of the lactic acid concentrating apparatus and the lactic acid polycondensing apparatus have at least a reactor, a feed port and a discharge port. Also, in these apparatus, there are provided an evacuator for evacuating the reactor and usually a thermometer. The type of reactor used in the present invention is not specifically defined; it is possible to use, for instance, a vertical, horizontal or tank-type reactor. As the agitator, it is possible to use, for instance, paddle, turbine, anchor, double-motion and helical ribbon agitators.

Heating in the reactor can be effected by the methods commonly used in the art. There are available the various methods, for example, a method in which a jacket of a heating medium is set around the reactor so that the reacting solution will be heated by heat transfer through the reactor wall, or a method in which a heating medium is passed inside the rotating shaft of the agitator to effect heating by heat transfer. These methods may be used either individually or in combination.

In the present invention, the water content in the gas phase in the lactic acid polycondensation reaction is measured. Measurement of water content in the gas phase includes detection of the presence or absence of water in the gas phase, quantification of water content and determination of the increase or decrease of water content. For measurement of water content in the gas phase, it is possible to employ the methods commonly used in the art, for example, a method in which a specified amount of gas is introduced into the reactor and cooled, and the condensate is titrated with a reagent (titration by Karl Fischer's reagent), a method in which a condenser is inserted into the gas flow region to measure electric capacity (electric capacity determination method), a method in which a specified amount of gas is introduced into the reactor and cooled, and the dew point temperature is determined (dew point determination method), and a method in which laser is irradiated in the gas flow region, and absorption of near infrared radiation by the water molecules is measured (laser irradiation absorption measurement method).

Progress of the polycondensation reaction causes a decrease of water produced incidentally to the reaction and a corresponding reduction of water content in the gas phase. It is therefore possible to confirm that the polycondensation reaction advanced sufficiently by recognizing a sufficient reduction of water content in the gas phase.

Water content in the gas phase can also be measured based on the variation of gas phase pressure. In this case, the increment of pressure relevant to water content in the gas phase is measured by a pressure gauge to thereby determine water content in the gas phase. In this case, too, it is possible to confirm sufficient progress of the polycondensation reaction by observing a sufficient lowering of gas phase pressure.

For measuring water content in the gas phase in the lactic acid polycondensation reaction, the amount of water in the gas phase transferred from the reactor by the evacuator set in the lactic acid polycondensing apparatus is measured by a water content meter fitted between the lactic acid polycondensing apparatus and the evacuator.

As means for measuring water content in the gas phase that matches the above-mentioned water content measuring method, there can be used, for instance, Carl Fischer's water content meter, electric capacity meter, dew point meter and spectrophotometer. As mentioned above, since measurement of gas phase pressure is included in the measurement of water content in the gas phase in the present invention, it is possible to employ a pressure gauge as the water content meter.

In the present invention, it is preferable to measure water content after lactic acid, lactic acid oligomer and lactide contained with water in the gas phase have been removed from the gas phase by condensation. Condensation is carried out at a temperature which causes lactic acid, lactic acid oligomer and lactide to condense but not water. It is therefore conducted at usually 80 to 110° C., preferably 90 to 100° C. The condensed lactic acid, lactic acid oligomer and lactide are preferably refluxed to the lactic acid polycondensation reaction step as this minimizes the loss of lactic acid, lactic acid oligomer and lactide and contributes to the improvement of lactide synthesis reaction yield.

Condensation of lactic acid, lactic acid oligomer and lactide contained in the gas phase can be accomplished by a condenser provided between the lactic acid polycondensing apparatus and the water content meter. By setting the condenser between the lactic acid polycondensing apparatus and the water content meter, it is possible to remove lactic acid, lactic acid oligomer and lactide contained in the gas phase before the gas phase transferred from the reactor reaches the water content meter. This makes it possible to prevent lactic acid, lactic acid oligomer and lactide from reaching the water content meter and the rearwardly located evacuator and depositing on their surfaces to cause operational troubles of these devices.

The said condenser includes reflux condenser. This reflux condenser serves for returning the condensed lactic acid, lactic acid oligomer and lactide back to the reactor of the lactic acid polycondensing apparatus.

After measuring the water content in the gas phase in the manner described above and confirming that the measured value of water content is smaller than a specified value, the lactic acid polycondensation reaction product is subjected to a depolymerization reaction. The “specified value” of water content in the gas phase referred to herein is not supposed to represent a definite value; it is a value that can be properly decided by those skilled in the art in consideration of the reaction conditions and other factors. It applies even in case where no water exists at all. In practical operation, it is confirmed that the water content in the gas phase by volume ratio is usually 4.0×10⁻¹ mol/m³ or less, preferably 1.2×10⁻¹ mol/m³ or less, more preferably 4.0×10⁻² mol/m³ or less and then the lactic acid polycondensation reaction product is subjected to a depolymerization reaction. In case of measuring water content in the gas phase by the gas phase pressure, it is confirmed that the increment of gas phase pressure in comparison with that before start of the polycondensation reaction is usually 10 Torr or less, preferably 3 Torr or less, more preferably 1 Torr or less, and then the lactic acid polycondensation reaction product is subjected to a depolymerization reaction.

In case the water content is measured with reference to the increment of gas phase pressure, lactic acid, lactic acid oligomer and lactide are eliminated by condensation before pressure is measured. This is necessary for excluding the increment of gas phase pressure related to lactic acid, lactic acid oligomer and lactide and for preventing these substances from depositing on the meters to cause troubles in their operations. In this case, a pressure gauge is used as the water content meter and a condenser is set between this pressure gauge and the lactic acid polycondensing apparatus.

Transfer of the lactic acid polycondensation reaction product to the depolymerization reactor can be effected by opening the discharge port of the polycondensation reactor after confirming that water content in the gas phase in the lactic acid polycondensing apparatus is below a specified value. Control of such a discharge port can be made by incorporating a system in which a signal is issued and sent to a discharge port control unit on confirming that the measured value of water content is smaller than a specified value by the water content meter, and the control unit operates in response to the said signal to open the valve of the discharge port. This makes it possible to carry out stabilized synthesis of an oligomer of which the polycondensation reaction has advanced to the extent of providing a specified average molecular weight.

The gas phase, with its water content measured, is further condensed to remove water and then discharged. Condensation is here carried out at a temperature of usually −10 to 80° C., preferably 0 to 10° C. In the lactide synthesizing apparatus according to the present invention, usually a condensing device such as cold trap is provided between the water content meter and the evacuator, and the gas phase is transferred into the evacuator for removing water and then discharged from the evacuator.

The term “lactic acid oligomer” used in the present invention is a designation of the lactic acid polymerizates ranging from dimers of lactic acid to its polymers with a molecular weight of up to about 50,000. The weight-average molecular weight of the lactic acid oligomer obtained from the said lactic acid polycondensation reaction is usually 1,000 to 10,000, preferably 3,000 to 5,000.

The lactic acid oligomer obtained from the polycondensation reaction may be once stored up in a reservoir, for example, oligomer feeder serving as a buffer tank and then sent to the depolymerizer, or it may be directly conveyed to the depolymerizer. The depolymerization reaction system may be either continuous or batch-wise. In case the depolymerization reaction is carried out continuously, it is preferable that the lactic acid oligomer be once stored up in the lactic acid oligomer feeder and thence sent continuously to the depolymerizer.

The lactic acid oligomer obtained from the polycondensation reaction of lactic acid is subjected to a depolymerization reaction to yield lactide. “Lactide” in the present invention designates a cyclic ester produced by eliminating 2 molecules of water from 2 molecules of lactic acid.

The depolymerization reaction of the lactic acid oligomer is carried out under heating and reduced pressure in the presence of a depolymerization catalyst, and the produced lactide is vaporized and recovered.

As the catalyst for the depolymerization reaction, it is possible to use those known as polymerization catalysts for lactic acid, for example the ones comprising metals selected from the group consisting of groups IA, IIIA, IVA, IIB and VA metals of the periodic table or the compounds of these metals.

The group IA metal compounds usable in the present invention include, for example, hydroxides of alkaline metals (such as sodium hydroxide, potassium hydroxide and lithium hydroxide), salts of alkaline metals and weak acids (such as sodium lactate, sodium acetate, sodium carbonate, sodium octylate, sodium stearate, potassium lactate, potassium acetate, potassium carbonate and potassium octylate), and alcoxides of alkaline metals (such as sodium methoxide, potassium methoxide, sodium ethoxide and potassium ethoxide).

The group IIIA metal compounds include, for example, aluminum ethoxide, aluminum isopropoxide, aluminum oxide, and aluminum chloride.

The group IVA metal compounds include, for example, organotin-based catalysts (such as tin lactate, tin tartrate, tin dicaprylate, tin dilaurylate, tin dipalmitate, tin distearate, tin dioleate, tin α-naphthoate, tin β-naphthoate and tin octylate), tin powder, tin oxide and tin halide.

The group IIB metal compounds include, for example, zinc powder, zinc halide, zinc oxide, and organozinc-based compounds.

Examples of the group IVB metal compounds include titanium-based compounds such as titanium tetrapropoxide, and zirconium-based compounds such as zirconium isopropoxide.

Exemplary of the group VA metal compounds are antimony-based compounds such as antimony trioxide, and bismuth-based compounds such as bismuth oxide (III).

Of these compounds, tin-based liquid catalysts such as tin octylate are preferred.

Such a catalyst is used in an amount of approximately 0.01 to 20% by weight, preferably 0.05 to 15% by weight, more preferably 0.1 to 10% by weight based on the lactic acid oligomer.

The depolymerization reaction can be executed by the lactic acid polycondensing apparatus or a depolymerizer located rearwardly of the lactic acid oligomer feeder. The depolymerizer has at least a reactor, a feed port and a discharge port. The depolymerizer is also equippped with an evacuator for evacuating the reactor and usually a thermometer. The reaction can be accomplished by an ordinary vertical, horizontal or tank type reactor or by using a molecular distiller. Various types of molecular distiller, such as pot still type, falling film flow type and centrifugal type can be used. The falling film flow type and centrifugal type are the continuous operation type and widely used in the industry. The centrifugal molecular distiller is of a system in which a film of evaporated material is spread on the heated surface by making use of centrifugal force, and the falling film flow type molecular distiller is of a system in which the evaporated material is let flow down along the heated surface to form a thin film.

As means for heating in the reactor, the various methods commonly used in the art can be employed, for example: a jacket of a heating medium is set around the reactor, and the reactant solution is heated by transfer of heat through the reactor wall; a heating medium is passed internally of the rotating shaft of the agitator to effect heating by heat transfer; a heat exchanger is set submerged in the area in the reactor where the lactic acid oligomer is charged. These methods may be used either independently or in combination.

The reaction temperature is set at usually 160 to 300° C., preferably 180 to 260° C., more preferably 190 to 250° C. Distillation of lactide is facilitated by setting the reaction temperature 160° C. or more, and racemization and tinting can be prevented by setting the reaction temperature 300° C. or less.

The internal pressure of the depolymerizer is adjusted to be not higher than vapor pressure of lactide in the said depolymerization temperature range; usually it is set at around 1 to 50 Torr. A low pressure is preferred as it allows a lowering of heating temperature. Accordingly, the preferred range of internal pressure of the depolymerizer is 1 to 20 Torr, more preferably 1 to 10 Torr, even more preferably 1 to 5 Torr.

The residence time in the depolymerizer is preferably as short as possible in view of prevention of racemization; usually it is within 10 hours, preferably within 4 hours.

The lactide produced under these operating conditions can be taken out of the depolymerization reaction system and collected as vapor. Collection of lactide can be easily accomplished using by a lactide condensing device fitted in the depolymerizer. In the present invention, as a lactic acid oligomer having a specified average molecular weight can be supplied stably to the depolymerizer, the water content in the synthesized lactide can be also accordingly reduced stably.

The lactide produced according to the present invention, if required, may be further refined and utilized for the polymerization reaction for the preparation of polylactic acid. Refinement can be accomplished according to, for example, a method described in JP-A-6-256340 “Melt crystallization refinement of lactide” or JP-A-7-118259 “Methods for refinement and polymerization of lactide”. The lactide obtained according to the present invention is free of water and high in purity, so that when these refinement methods are practiced, it is possible to notably reduce their loads.

The present invention will be described in further detail with reference to the examples thereof, but these examples are merely intended to be illustrative and not to be construed as limiting the scope of the invention.

### EXAMPLES

### Example 1

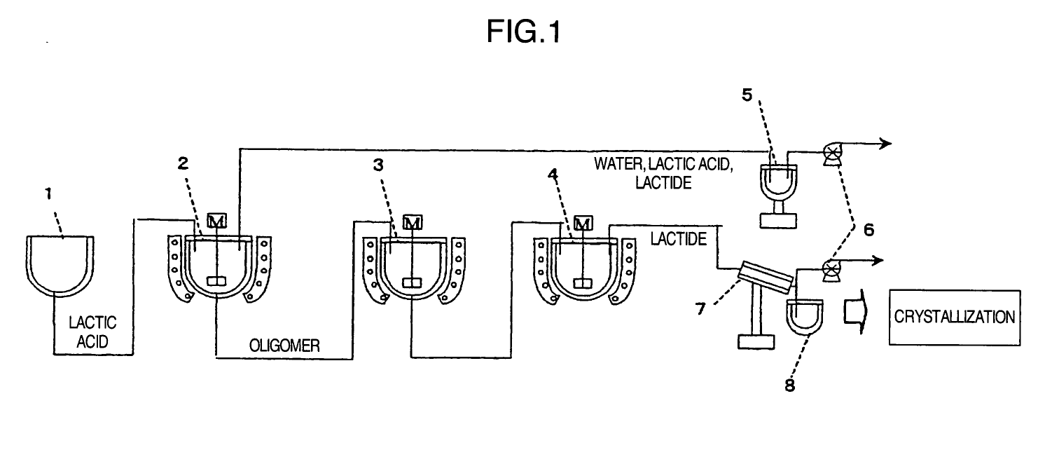

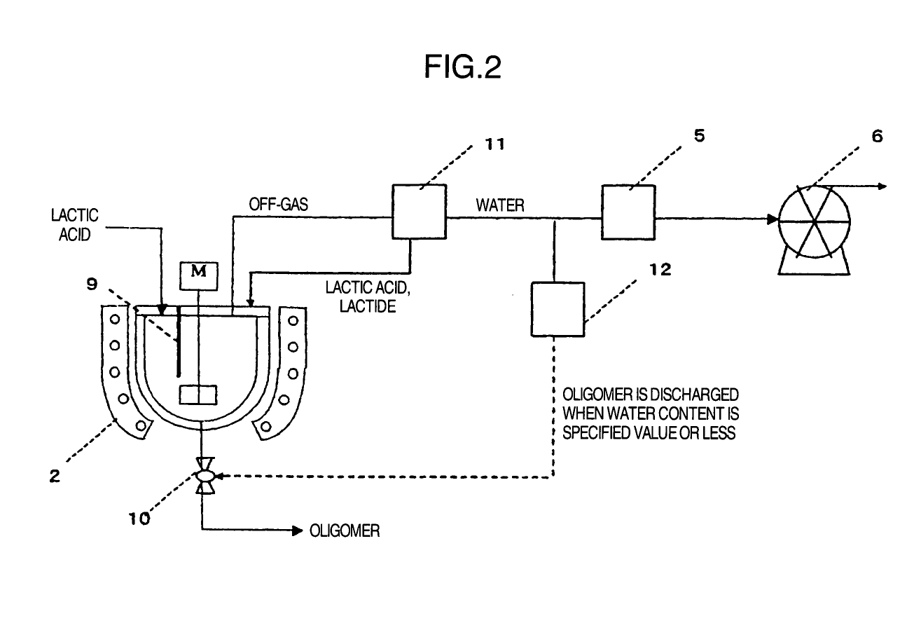

FIG. 1 illustrates an example of lactide producing process according to the present invention, and FIG. 2 shows, on an enlarged scale, an example of lactic acid polycondensation reaction in the lactide producing process illustrated in FIG. 1.

The lactide synthesizing apparatus in the instant embodiment of the present invention comprises a lactic acid feeder 1, a lactic acid polycondensing apparatus 2, an oligomer feeder 3, a depolymerizer 4, a cold trap 5, an evacuator 6, a lactide condensing device 7, and a lactide recovery tank 8 (FIG. 1), and is also equipped with a thermometer 9 for the lactic acid polycondensing apparatus, a lactic acid oligomer discharge valve 10, a condensing device 11, and a pressure gauge 12 (FIG. 2).

First, lactic acid oligomer discharge valve 10 is closed to transfer lactic acid to lactic acid polycondensing apparatus 2 from lactic acid feeder 1. In lactic acid feeder 1, a catalyst for accelerating the polycondensation reaction is added as required to lactic acid.

In lactic acid polycondensing apparatus 2, water contained in lactic acid is evaporated by heating (concentration step) while advancing the polycondensation reaction of lactic acid and evaporating the concomitantly produced water (polycondensation step). Using lactic acid polycondensing apparatus thermometer 9, the reaction is allowed to proceed at a temperature of 120 to 250° C., or the reaction is let advance while gradually heating the reaction system in the said temperature range. Lactic acid polycondensing apparatus 2 is evacuated to 5 Torr or below.

In the lactic acid concentration reaction and the lactic acid polycondensation reaction, water, lactic acid, a low-molecular weight lactic acid oligomer and its decomposition product lactide are produced in a gaseous form. These gaseous materials are transferred toward evacuator 6 from lactic acid polycondensing apparatus 2. They first enter condensing device 11 in which lactic acid, low-molecular weight lactic acid oligomer and lactide were eliminated from the gaseous body and refluxed to lactic acid polycondensing apparatus 2. Condensing device 11 used here is of a condenser type. The gaseous body cleared of lactic acid, low-molecular weight lactic acid oligomer and lactide is passed into pressure gauge 12 where the water content in the gaseous body is measured. Then the gaseous body reaches cold trap 5 where water is removed, and the dehydrated gaseous body is discharged from evacuator 6.

After confirming that the water content in the gaseous body is below a specified level through the measurement by pressure gauge 12, lactic acid oligomer discharge valve 10 is opened to pass the lactic acid oligomer into lactic acid oligomer feeder 3 shown in FIG. 1. This lactic acid oligomer feeder 3 is substantially a buffer tank from which the lactic acid oligomer is supplied continuously to depolymerizer 4. Production of lactide consequent on the depolymerization reaction of the lactic acid oligomer proceeds continuously. In case lactide production is conducted by a batch process, the lactic acid oligomer may be passed directly to depolymerizer 4 by skipping lactic acid oligomer feeder 3.

A lactic acid concentrator may be connected in series to and forwardly of lactic acid polycondensing apparatus 2. In this case, such a lactic acid concentrator is also provided with a cold trap, an evacuator, a thermometer, a discharge valve, a condensing device and a pressure gauge. When the water content in the gas produced in the lactic acid concentrating apparatus was sufficiently reduced, achieving the desired concentration to a certain extent, the concentrated lactic acid is transferred to the lactic acid polycondensing apparatus.

The gaseous lactide produced as a result of depolymerization is cooled down to a liquid by condensing device 7 and recovered in its recovery tank 8. The lactide-freed gas is discharged from evacuator 6.

### Example 2

In the procedure shown in Example 1 above, a lactic acid oligomer was produced from lactic acid.

In lactic acid polycondensing apparatus 2, 90% lactic acid (containing 10% of water) was maintained under a pressure of 1 atm (in a nitrogen atmosphere) at 135° C. for 3 hours to evaporate water, forming concentrated lactic acid. Then the temperature was raised at a rate of 10° C./h under reduced pressure till reaching 170° C., and this temperature was maintained. After confirming that the generation of water consequent on the polycondensation reaction of lactic acid has ceased, that is, that the increase of pressure has become no longer recognizable by pressure gauge 12, lactic acid oligomer discharge valve 10 was opened to discharge the lactic acid oligomer. The weight-average molecular weight of the obtained lactic acid oligomer was approximately 3,000.

The lactic acid oligomer obtained in the manner described above was subjected to a depolymerization reaction to produce lactide. To this lactide were added a polymerization initiator and a catalyst, and the mixture was maintained at 170° C. for 10 hours with stirring in an inert gas environment of 1 atm, and then, with continued stirring, further maintained at 190° C. for 5 hours. As a result, it has become apparent that polylactic acid having a weight-average molecular weight of 200,000 to 250,000 can be synthesized steadily by the above process.

According to the present invention as described above, in the synthesis of lactide, it is possible to reduce water content in lactide being synthesized and produce lactide suited for the ring-opening polymerization by controlling water content in the lactic acid polycondensation reaction or a physical quantity having a direct interrelation therewith. It is also possible to enhance the yield in synthesizing polylactic acid from starting lactic acid by suppressing production of lactides of the type unsuited for ring-opening polymerization which is produced due to variation of water content.

It should be further understood by those skilled in the art that although the foregoing description has been made on embodiments of the invention, the invention is not limited thereto and various changes and modifications may be made without departing from the spirit of the invention and the scope of the appended claims.

### ADVANTAGES OF THE INVENTION

The present invention makes it possible to synthesize lactide with a low water content from lactic acid in a stabilized manner. Also, efficient and high-yield synthesis of polylactic acid is realized by synthesizing polylactic acid by subjecting lactide obtained according to the present invention to a ring-opening polymerization.

1. A method of producing a lactide comprising the steps of:
polycondensing a lactic acid under reduced pressure to form a lactic acid oligomer; and
depolymerizing the obtained lactic acid oligomer,
wherein a water content in a gas phase in the lactic acid polycondensation reaction is measured, and, after confirming that the measured value of water content is smaller than a specified value, said lactic acid oligomer is subjected to the depolymerization reaction.

2. A method of synthesizing a lactide comprising the steps of:
using a lactide synthesizing apparatus comprising a lactic acid polycondensing apparatus, an evacuator for evacuating said lactic acid polycondensing apparatus, and a lactic acid oligomer depolymerizer;
measuring a water content in a gas phase in the polycondensation reaction by a water content meter set between said lactic acid polycondensing apparatus and said evacuator; and
after confirming that the measured value of water content is smaller than a specified value, opening a discharge port of the polycondensing apparatus to subject a resulting product to a depolymerization reaction.

3. The method according to claim 2 further including the step of condensing a lactic acid, a lactic acid oligomer and a lactide in the gas phase by a condenser provided between the lactic acid polycondensing apparatus and the water content meter.

4. An apparatus for synthesizing a lactide, comprising:
a lactic acid polycondensing apparatus;
an evacuator for evacuating an inside of said lactic acid polycondensing apparatus; and
a lactic acid oligomer depolymerizer,
wherein a water content meter for measuring a water content in a gas phase is set between said lactic acid polycondensing apparatus and said evacuator, and
the lactic acid polycondensing apparatus is provided with a discharge port which is opened or closed in response to an output signal from said water content meter.

5. The apparatus according to claim 4 further including a condenser provided between the lactic acid polycondensing apparatus and the water content meter.
